(19) United States
(12) Patent Application Publication
(10) Pub. No.: US 2017/0136913 A1
(43) Pub. Date: May 18, 2017

(54) APPARATUS AND METHOD FOR DETECTING RELAY FUSION OF ECO-FRIENDLY VEHICLE

(71) Applicant: Hyundai Motor Company, Seoul (KR)

(72) Inventors: Hee Tae Yang, Seoul (KR); Yu Seok Kim, Seoul (KR); Ho Joong Lee, Anyang (KR)

(21) Appl. No.: 15/180,522

(22) Filed: Jun. 13, 2016

(30) Foreign Application Priority Data
Nov. 18, 2015 (KR) 10-2015-0161927

(51) Int. Cl. B60L 11/18

(52) U.S. Cl. CPC B60L 11/1859; B60L 11/1861; B60L 11/1811

(57) ABSTRACT

An apparatus and a method for detecting a relay fusion of an eco-friendly vehicle are provided. The apparatus and method detect whether a relay for preventing an over-discharge of a lithium ion battery of 12V is fused, by ascertaining a voltage change of the lithium ion battery of 12V based on a variation of an output voltage of a low direct current (DC)-DC converter (LDC).

### CROSS-REFERENCE TO RELATED APPLICATION

This application is based on and claims the benefit of priority to Korean Patent Application No. 10-2015-0161927, filed on Nov. 18, 2015 in the Korean Intellectual Property Office, the disclosure of which is incorporated herein in its entirety by reference.

### TECHNICAL HELD

The present disclosure relates to an apparatus and a method for detecting a relay fusion of an eco-friendly vehicle, and more particularly, to a technology of detecting whether a relay is fused to prevent an over-discharge of a lithium ion battery of 12V in an eco-friendly vehicle. In the present disclosure, the eco-friendly vehicle, which is a vehicle being driven by driving an electric motor using a high voltage battery, includes a hybrid electric vehicle (HEV), an electric vehicle (EV), a plug-in hybrid electric vehicle (PHEV), a fuel cell electric vehicle (FCEV), or the like.

### BACKGROUND

An eco-friendly vehicle generally includes a high voltage battery configured to supply driving power, and an auxiliary battery configured to supply operation power to internal electric apparatuses (electronic loads). Particularly, a low voltage direct current (DC)-DC converter (LDC) connected to the auxiliary battery and the electric apparatuses down-converts a high voltage of the high voltage battery into a charging voltage of the auxiliary battery when a voltage of the auxiliary battery is less than a reference value under operation of an upper controller, thereby charging the auxiliary battery with the charging voltage.

The auxiliary battery is configured to start an ignition of a vehicle and supply the operation power to the electric apparatuses such as a variety of lamps, a system, electronic control units (ECU), and the like. Until now, as the auxiliary battery of the vehicle, a lead-acid storage battery has been mainly used due to an advantage that it may be recharged to be used even when fully discharged. However, since the lead-acid storage battery is heavy, has low charging density, and particularly includes lead-acid, which is an environmental pollutant, the lead-acid storage battery is recently being replaced with a lithium ion battery in the eco-friendly vehicle.

However, the lithium ion battery has a disadvantage in that the lithium ion battery may not be recharged when it is over-discharged. Accordingly, technologies of preventing the over-discharge of the lithium ion battery such as a battery management system including a relay for preventing an over-discharge have been developed. Recently, since the relay performing such an important role is often frequently fused by a transient current, a solution for such relay fusion is demanded.

In the related art, an apparatus has been developed for detecting a relay fusion including a main battery system including a main battery of a vehicle, a main relay intermitting power of the main battery, and a first capacitor connected to the main battery, a quick charging system electrically connected to the main battery system and including a quick charging relay and a second capacitor, and a controller configured to detect a change of the main battery system and the quick charging system during a precharging to determine whether a relay is fused. However, the apparatus for detecting a relay fusion according to the related art described above, which is a technology for detecting the fusion of the main relay intermitting power of the high voltage battery, has a problem that it may not be applied to detect a fusion of a relay for preventing an over-discharge of a lithium ion battery of 12V.

### SUMMARY

The present disclosure provides an apparatus and a method for detecting a relay fusion of an eco-friendly vehicle capable of detecting whether a relay for preventing an over-discharge of a lithium ion battery of 12V is fused, by ascertaining a voltage change of the lithium ion battery of 12V based on a variation of an output voltage of a low direct current (DC)-DC converter (LDC).

The objects of the present disclosure are not limited to the above-mentioned objects, and other objects and advantages of the present disclosure can be appreciated by the following description and will be clearly described by the exemplary embodiments of the present disclosure. Further, it will be easily known that the objects and advantages of the present disclosure can be implemented by means shown in the appended claims and a combination thereof.

According to an exemplary embodiment of the present disclosure, an apparatus for detecting a relay fusion of an eco-friendly vehicle may include a voltage sensor configured to sense a voltage of a first battery; a relay configured to prevent an over-discharge of the first battery; a low direct current (DC)/DC converter (LDC) configured to convert a high voltage of a second battery into a low voltage; and a controller configured to match an output voltage of the converter to be equal to the voltage of the first battery, to set the converter to a regular operation mode and then turn off the relay, and to monitor a voltage change of the first battery while adjusting the output voltage of the converter to determine that the fusion does not occur when the voltage of the first battery is not changed and determine that the fusion occurs when the voltage of the first battery is changed.

The controller may further be configured to determine whether the relay is fused and then again match or adjust the output voltage of the converter to be equal to the voltage of the first battery, and turn on the relay and then release the regular operation mode of the converter. The controller may include a first switch used to turn off the relay and a second switch used to turn on the relay. The apparatus may further include a current sensor configured to sense a current of the first battery, and the controller may be configured to determine whether the relay is fused by considering both the voltage change and a current change of the first battery. When a speed of the vehicle exceeds a first threshold value and the voltage of the first battery exceeds a second threshold value, the controller may be configured to detect the fusion of the relay. The first battery may be a lithium ion battery of 12V and the relay may be a latching type relay controlled by a pulse signal.

According to another exemplary embodiment of the present disclosure, a method for detecting a relay fusion in an eco-friendly vehicle including a voltage sensor, a current sensor, a relay for preventing an over-discharge of a first battery, and a converter may include matching an output voltage of the converter to be equal to a voltage of the first battery; setting the converter to a regular operation mode and then turning off the relay; monitoring a voltage change of the first battery while adjusting the output voltage of the converter, determining that the fusion does not occur when the voltage of the first battery is not changed; and determining that the fusion occurs when the voltage of the first battery is changed.

### BRIEF DESCRIPTION OF THE DRAWINGS

The above and other objects, features and advantages of the present disclosure will be more apparent from the following detailed description taken in conjunction with the accompanying drawings.

FIG. 1 is a configuration diagram of an apparatus for detecting a relay fusion of an eco-friendly vehicle according to an exemplary embodiment of the present disclosure; and

FIG. 2 is a flowchart of a method for detecting a relay fusion of an eco-friendly vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The above-mentioned objects, features, and advantages will become obvious from the detailed description described below with reference to the accompanying drawings. Therefore, those skilled in the art to which the present disclosure pertains may easily practice a technical idea of the present disclosure. Further, in describing the present disclosure, in the case in which it is judged that a detailed description of a well-known technology associated with the present disclosure may unnecessarily make the gist of the present disclosure unclear, it will be omitted. Hereinafter, exemplary embodiments of the present disclosure will be described in detail with reference to the accompanying drawings.

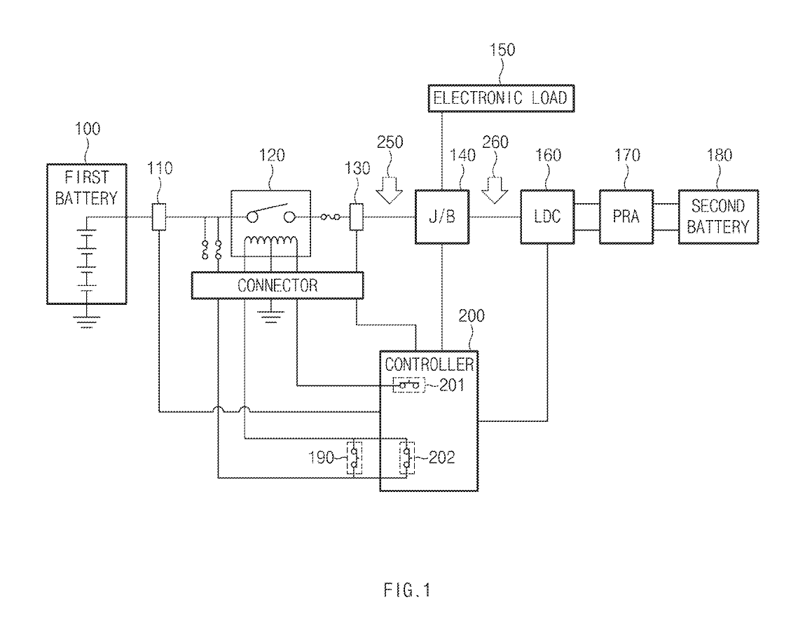

FIG. 1 is a configuration diagram of an apparatus for detecting a relay fusion of an eco-friendly vehicle according to an exemplary embodiment of the present disclosure. As illustrated in FIG. 1, the apparatus for detecting a relay fusion of an eco-friendly vehicle according to the present disclosure may include a first battery 100, a voltage sensor 110, a relay 120, a current sensor 130, a junction box (J/B) 140, an electronic load 150, a low DC/DC converter (LDC) 160, a power relay assembly (PRA) 170, a second battery 180, a user switch 190, and a controller 200. The controller 20 may be configured to operate the various elements of the apparatus.

The respective components described above will be described. First, the first battery 100, which may be, for example, a lithium ion battery of 12V (e.g., a low voltage auxiliary battery), may be configured to supply power necessary to start an engine of a vehicle and power required by the electronic load 150. The voltage sensor 110 may be configured to sense a voltage of the first battery 100. The relay 120 may be configured to supply power from the first battery 100 to the electronic load 150 or to block the power from the first battery 100, thereby making it possible to prevent an over-discharge of the first battery 100. Further, the relay 120 may also be configured to completely block the first battery 100 from a dark current flowing in the electronic load 150. In particular, the relay 120 may be implemented as a latching type relay controlled by a pulse signal.

Further, the current sensor 130, which is an additional element according to the present disclosure, may be disposed between the relay 120 and the junction box 140 to sense a current of the first battery 100. The junction box 140 may include a line for performing a branching of the power of the first battery 100 into each electronic load 150. The LDC 160 may be configured to convert a high voltage of the first battery 180 into a low voltage (e.g., about 14.3V to 13.5V) to charge the first battery 100 or to supply rated power required by each electronic load 150. Particularly, the LDC 160 may be configured to supply the power to the controller 200.

The power relay assembly 170 may also include two relays, which are main power contact points, and a precharge relay and a precharge resistance installed on a circuit bypassing one relay of the two relays. In other words, a first relay (i.e., a positive (+) relay) may be disposed on a circuit between a positive (+) terminal of the second battery 180 and a positive (+) terminal of a DC link, and a second relay (i.e., a negative (−) relay) may be disposed on a circuit between a negative (−) terminal of the second battery 180 and a negative (−) terminal of the DC link, such that the precharge relay and the precharge resistance are provided on a bypass circuit bypassing the first relay. The above-mentioned two relays included in the power relay assembly 170 may be controlled by a relay control signal output from a battery management system or a motor controller unit (MCU).

Additionally, the second battery 180, which may be a high voltage battery, may be configured to supply electrical energy necessary to assist in a motor during accelerating of the vehicle, and store electrical energy generated by a motor regeneration during decelerating of the vehicle or occurring of an engine margin output. The user switch 190, which is a passive switch, may be operated by a user manipulation and may be used to turn on the relay 120. In other words, when the controller 200 turns off the relay 120 to prevent the over-discharge of the first battery 100 during a long-term parking, when the user switch is turned on, the relay 120 may be turned on to supply the power from the first battery 100 to the electronic load 150.

The controller 200 may be configured to execute a general control so that the respective components may normally perform own functions. Particularly, when a speed of the vehicle exceeds a first threshold value and the voltage of the first battery 100 exceeds a second threshold value, the controller 200 may be configured to detect whether the relay 120 is fused. In other words, as the controller 200 enters a fusion detection mode of the relay 120, the controller 200 may be configured to match or adjust an output voltage of the LDC 160 to be equal to the voltage of the first battery 100. For example, when the voltage of the first battery 100 is about 12.5V, the controller 200 may be configured to set the output voltage of the LDC 160 to about 12.5V. Accordingly, a fusion may be prevented which may occur when the relay 120 is turned off in advance.

Particularly, the speed of the vehicle may be obtained by a vehicle network The vehicle network may include a controller area network (CAN), a local interconnect network (LIN), a flexray, a media oriented system transport (MOST), or the like. Thereafter, the controller 200 may be configured to set the LDC 160 to a regular operation mode and then turn off the relay 120 using a first switch 201. Accordingly, a variety of devices in the vehicle may be operated normally even though the relay 120 is turned off and the power from the first battery 100 is blocked. In particular, the power may be supplied from the LDC 160. The regular operation mode is a state in which whether the LDC 160 is operated is not determined based on a specific condition, but the LDC 160 is always operated regardless of conditions.

Thereafter, the controller 200 may be configured to monitor a voltage change of the first battery 100 while arbitrarily adjusting the output voltage of the LDC 160 within a threshold range. In particular, when the fusion does not occur in the relay 120, the relay 120 may be in a turned off state. As a result, since a connection between the first battery 100 and the LDC 160 is blocked, the voltage change of the first battery 100 will not occur even when the output voltage of the LDC 160 is adjusted. However, when the fusion occurs in the relay 120, the relay 120 may be configured to maintain a turned on state even when the first switch 201 is turned off. As a result, a change of the voltage of the first battery 100 may also occur based on the output voltage of the LDC 160.

As a result, the controller 200 may be configured to determine that the fusion does not occur when the change of the voltage of the first battery 100 does not occur, and determine that the fusion occurs when the change of the voltage of the first battery 100 occurs, using the above-mentioned principle. Further, the controller 200 may be configured to again match or adjust the output voltage of the LDC 160 to be equal to the voltage of the first battery 100, and then may be configured to turn on the relay 120 using a second switch 202 to supply the power of the first battery 100 to each electronic load 150. Thereafter, the controller 200 may be configured to release the regular operation mode of the LDC 160.

According to the present disclosure, a condition for entering the fusion detection mode of the relay 120 may be set, when the condition is satisfied, the entrance into the fusion detection mode of the relay 120 may be performed, and particularly, the LDC 160 may be set to the regular operation mode before blocking the relay 120 supplying the power to a variety of controllers as well as a variety of electronic loads in the vehicle, thereby making it possible to perform a process of detecting the fusion of the relay 120 by receiving the power from the LDC 160 even though the power from the first battery 100 is blocked.

Further, the present disclosure performs a process of matching the output voltage of the LDC 160 to the voltage of the first battery 100 to prevent the fusion which may occur when the relay 120 is turned on/off in advance, and includes a process of releasing the regular operation mode set in the LDC 160 when the process of detecting the fusion of the relay 120 is completed. Meanwhile, reference numerals ‘250’ and ‘260 in FIG. 1 each indicate points to which external power is applied while performing an after service (A/S) repair or attempting an ignition using the external power. The fusion of the relay 120 occurs due to the application of the external power.

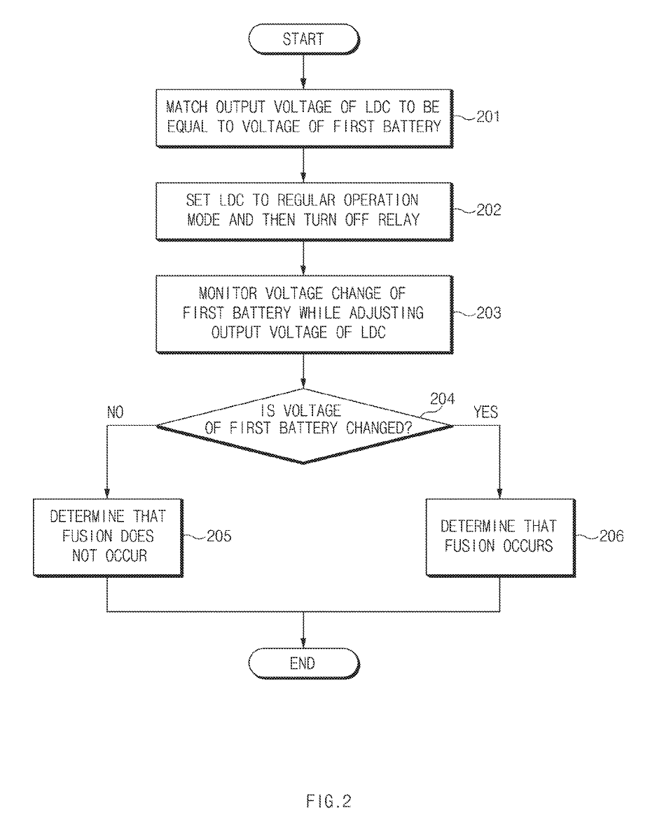

FIG. 2 is a flowchart of a method for detecting a relay fusion of an eco-friendly vehicle according to an exemplary embodiment of the present disclosure, and illustrates a process of detecting a relay fusion in the eco-friendly vehicle including the voltage sensor 110, the current sensor 130, the relay 120 for preventing an over-discharge of the first battery 100, and a low DC/DC converter (LDC) 160.

First, the controller 200 may be configured to match or adjust an output voltage of the LDC 160 to be equal to a voltage of the first battery 100 (201). The controller 200 may then be configured to set the LDC 160 to a regular operation mode and then turn off the relay 120 (202). Further, the controller 200 may be configured to monitor a voltage change of the first battery 100 while adjusting the output voltage of the LDC 160 (203). The controller 200 may be configured to determine whether a voltage of the first battery is changed (204). As a result of the determination (204), when the voltage of the first battery is not changed, the controller 200 may be configured to determine that a fusion does not occur (205). As a result of the determination (204), when the voltage of the first battery is changed, the controller 200 may be configured to determine that a fusion occurs (206).

Meanwhile, the method according to the present disclosure as described above may be created by a computer program. Codes and code segments configuring the computer program may be easily deduced by computer programmers in the art. In addition, the created computer program is stored in a computer readable recording medium (information storage medium) and is read and executed by computers, thereby implementing the method according to the present disclosure. In addition, the recording medium includes all types of computer readable recording media.

As described above, according to the exemplary embodiments of the present disclosure, whether the relay for preventing the over-discharge of the lithium ion battery of 12V is fused may be detected by ascertaining the voltage change of the lithium ion battery of 12V according to the variation of the output voltage of the LDC. Further, whether the relay for preventing the over-discharge of the lithium ion battery of 12V is fused may be detected while the eco-friendly vehicle is being driven. Additionally, whether the relay for preventing the over-discharge of the lithium ion battery of 12V is fused is detected, thereby making it possible to prevent the over-discharge of the lithium ion battery of 12V.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for detecting a relay fusion of an eco-friendly vehicle, comprising:
a voltage sensor configured to sense a voltage of a first battery;
a relay configured to prevent an over-discharge of the first battery;
a converter configured to convert a high voltage of a second battery into a low voltage; and
a controller configured to adjust an output voltage of the converter to be equal to the voltage of the first battery, to set the converter to a regular operation mode and then turn off the relay, and to monitor a voltage change of the first battery while adjusting the output voltage of the converter to determine that the fusion does not occur when the voltage of the first battery is not changed and determine that the fusion occurs when the voltage of the first battery is changed.

2. The apparatus according to claim 1, wherein the controller is configured to determine whether the relay is fused and again adjust the output voltage of the converter to be equal to the voltage of the first battery, and turn on the relay and release the regular operation mode of the converter.

3. The apparatus according to claim 2, wherein the controller includes a first switch for turning off the relay and a second switch for turning on the relay.

4. The apparatus according to claim 1, further comprising:
a current sensor configured to sense a current of the first battery.

5. The apparatus according to claim 4, wherein the controller is configured to determine whether the relay is fused by considering both the voltage change and a current change of the first battery.

6. The apparatus according to claim 1, wherein when a speed of the vehicle exceeds a first threshold value and the voltage of the first battery exceeds a second threshold value, the controller is configured to detect the fusion of the relay.

7. The apparatus according to claim 1, wherein the first battery is a lithium ion battery of 12V.

8. The apparatus according to claim 1, wherein the relay is a latching type relay controlled by a pulse signal.

9. A method for detecting a relay fusion in an eco-friendly vehicle including a voltage sensor, a current sensor, a relay for preventing an over-discharge of a first battery, and a converter, the method comprising:
adjusting, by a controller, an output voltage of the converter to be equal to a voltage of the first battery;
setting, by the controller, the converter to a regular operation mode and then turning off the relay;
monitoring, by the controller, a voltage change of the first battery while adjusting the output voltage of the converter, determining, by the controller, that the fusion does not occur when the voltage of the first battery is not changed; and
determining, by the controller, that the fusion occurs when the voltage of the first battery is changed.

10. The method according to claim 9, further comprising:
determining, by the controller, whether the relay is fused and again adjusting the output voltage of the converter to be equal to the voltage of the first battery; and
turning on, by the controller, the relay and releasing the regular operation mode of the converter.

11. The method according to claim 10, wherein the relay is turned off by a first switch and is turned on by a second switch.

12. The method according to claim 9, further comprising:
sensing, by the current sensor, a current of the first battery.

13. The method according to claim 12, wherein in the determination process, whether the relay is fused is determined by further considering a current change of the first battery.

14. The method according to claim 9, wherein a process of detecting whether the relay is fused is performed when a speed of the vehicle exceeds a first threshold value and the voltage of the first battery exceeds a second threshold value.

15. The method according to claim 9, wherein the first battery is a lithium ion battery of 12V.

16. The method according to claim 9, wherein the relay is a latching type relay controlled by a pulse signal.

17. A non-transitory computer readable medium containing program instructions executed by a controller for detecting a relay fusion in an eco-friendly vehicle including a voltage sensor, a current sensor, a relay for preventing an over-discharge of a first battery, and a converter, the computer readable medium comprising:
program instructions that adjust an output voltage of the converter to be equal to a voltage of the first battery;
program instructions that set the converter to a regular operation mode and then turning off the relay;
program instructions that monitor a voltage change of the first battery while adjusting the output voltage of the converter,
program instructions that determine that the fusion does not occur when the voltage of the first battery is not changed; and
program instructions that determine that the fusion occurs when the voltage of the first battery is changed.
